(19) United States
(12) Patent Application Publication
(10) Pub. No.: US 2025/0062581 A1
(43) Pub. Date: Feb. 20, 2025

(54) Cable Insertion Device and Connector Manufacturing Device

(71) Applicant: Tyco Electronics (Shanghai) Co., Ltd., Shanghai (CN)

(72) Inventors: Jianguo (Thomas) Yang, Shanghai (CN); Lijiong Zhang, Shanghai (CN)

(73) Assignee: Tyco Electronics (Shanghai) Co., Ltd., Shanghai (CN)

(21) Appl. No.: 18/807,270

(22) Filed: Aug. 16, 2024

(30) Foreign Application Priority Data
Aug. 16, 2023 (CN) 202311036673.8

(51) Int. Cl. H01R 43/20

(52) U.S. Cl. CPC H01R 43/20

(57) ABSTRACT

A cable insertion device includes a first block having a row of slots and a second block assembled onto the first block. A row of upper semicircular holes corresponding to the row of slots is formed on the second block. The cable insertion device includes a third block assembled onto the first block. A row of lower semicircular holes corresponding to the row of slots is formed on the third block. One of the upper semicircular holes and one of the lower semicircular holes are combined into a guide hole for guiding a cable into a cable hole of a connector housing. The cable insertion device includes a locking component clamped between the first block and the third block and having elastic cantilevers corresponding to the slots. Each of the elastic cantilevers extends into one of the slots and rests against the cable inserted into the cable hole.

### CROSS-REFERENCE TO RELATED APPLICATION

This application claims the benefit of the filing date under 35 U.S.C. § 119(a)-(d) of Chinese Patent Application No. 202311036673.8, filed on Aug. 16, 2023.

### FIELD OF THE INVENTION

The present invention relates to a cable insertion device and a connector manufacturing device comprising the cable insertion device.

### BACKGROUND OF THE INVENTION

A connector typically includes a housing, a terminal, and a cable. The terminal is provided in the housing, and the cable is inserted into the housing. Usually, the terminal needs to be crimped onto the cable. To ensure that the cable remains stationary during crimping, a cable clamp is required to clamp and secure the cable. This increases the installation steps of the connector and reduces manufacturing efficiency.

### SUMMARY OF THE INVENTION

A cable insertion device includes a first block having a row of slots and a second block assembled onto the first block. A row of upper semicircular holes corresponding to the row of slots is formed on the second block. The cable insertion device includes a third block assembled onto the first block. A row of lower semicircular holes corresponding to the row of slots is formed on the third block. One of the upper semicircular holes and one of the lower semicircular holes are combined into a guide hole for guiding a cable into a cable hole of a connector housing. The cable insertion device includes a locking component clamped between the first block and the third block and having elastic cantilevers corresponding to the slots. Each of the elastic cantilevers extends into one of the slots and rests against the cable inserted into the cable hole.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a cable insertion device according to an exemplary embodiment of the present invention;

FIG. 2 shows an illustrative perspective view of a cable insertion device according to an exemplary embodiment of the present invention, where a second block is not shown;

FIG. 3 shows an illustrative sectional view of a cable insertion device according to an exemplary embodiment of the present invention;

FIG. 4 shows an illustrative exploded view of a cable insertion device according to an exemplary embodiment of the present invention;

FIG. 5 shows an illustrative perspective view of the first and second blocks of the cable insertion device according to an exemplary embodiment of the present invention;

FIG. 6 shows an illustrative perspective view of the first block and locking component of the cable insertion device according to an exemplary embodiment of the present invention;

FIG. 7 shows a cross-sectional view of the cable insertion device and connector housing according to an exemplary embodiment of the present invention; and

FIG. 8 shows an illustrative view of the cable insertion device and connector housing shown in FIG. 7.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

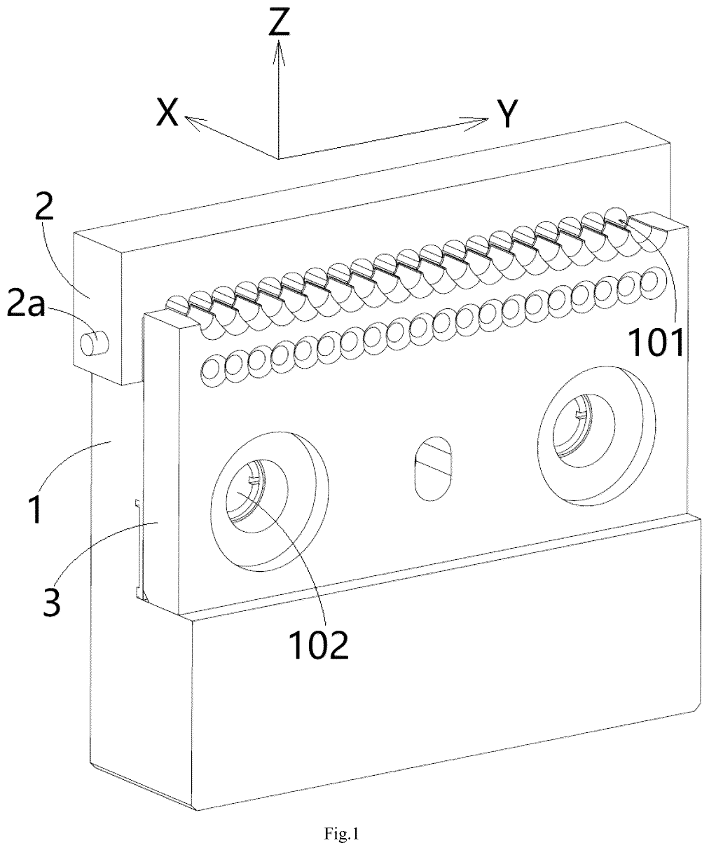

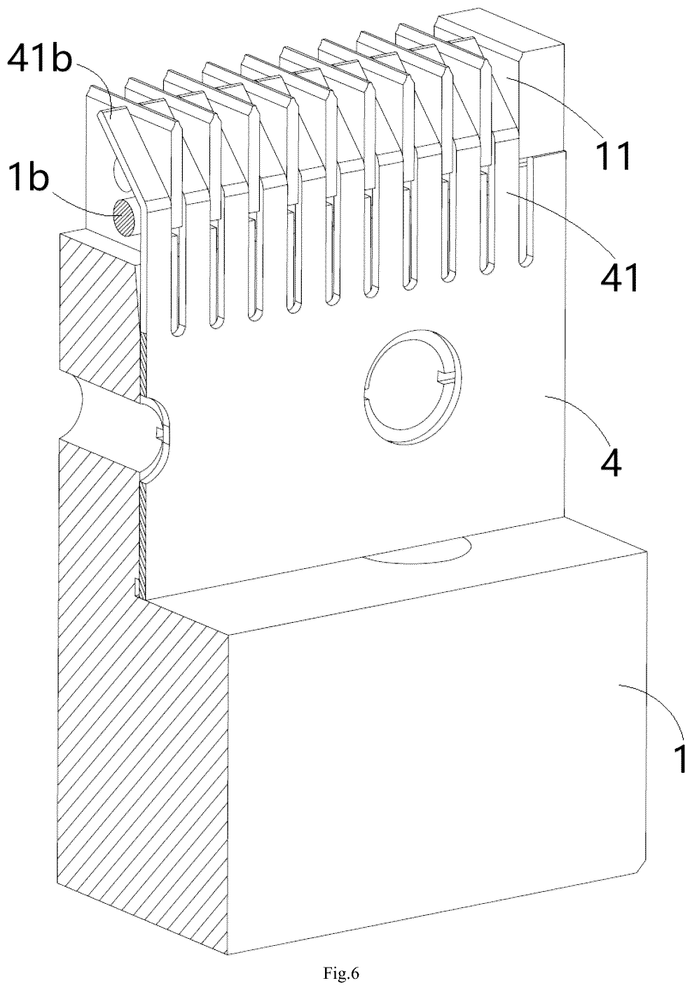

As shown in FIGS. 1 to 6, in an exemplary embodiment of the present invention, a cable insertion device is disclosed. The cable insertion device includes: a first block 1, a second block 2, a third block 3, and a locking component 4. The first block 1 has opposite top and bottom surfaces in the vertical direction Z, as well as opposite front and rear sides in the first horizontal direction X. The second block 2 is assembled to the top of the first block 1 and a bottom surface of the second block 2 is against the top surface of the first block 1. The third block 3 is assembled to the front side of the first block 1. The locking component 4 is clamped between the first block 1 and the third block 3.

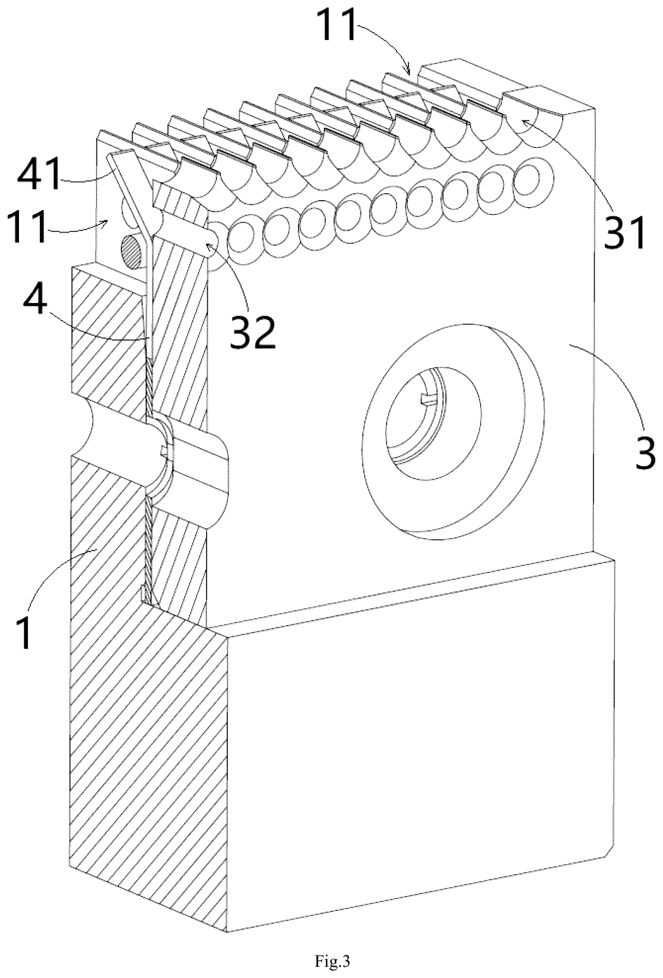

As shown in FIGS. 3 to 6, in the illustrated embodiments, a row of slots 11 is formed on the top surface of the first block 1, a row of upper semicircular holes 21 corresponding to the row of slots 11 is formed on the bottom surface of the second block 2, and a row of lower semicircular holes 31 corresponding to the row of slots 11 is formed on the top surface of the third block 3. The upper semicircular hole 21 and the lower semicircular hole 31 are combined into a guide hole 101, shown in FIG. 1, for guiding a cable 6 into a cable hole 51 of a connector housing 5.

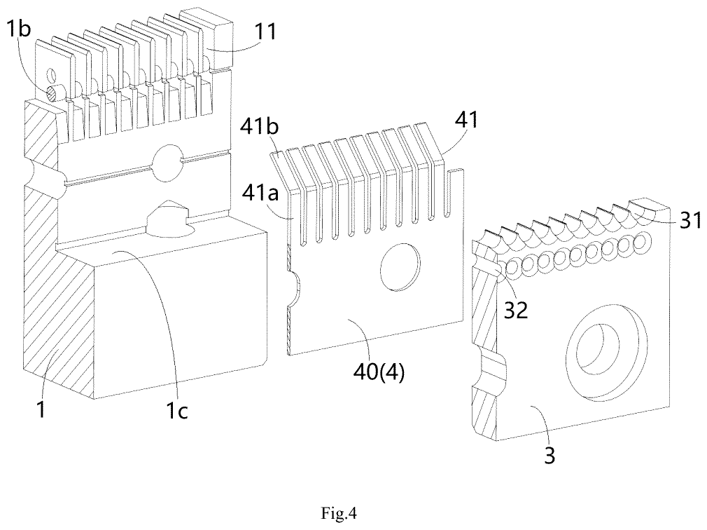

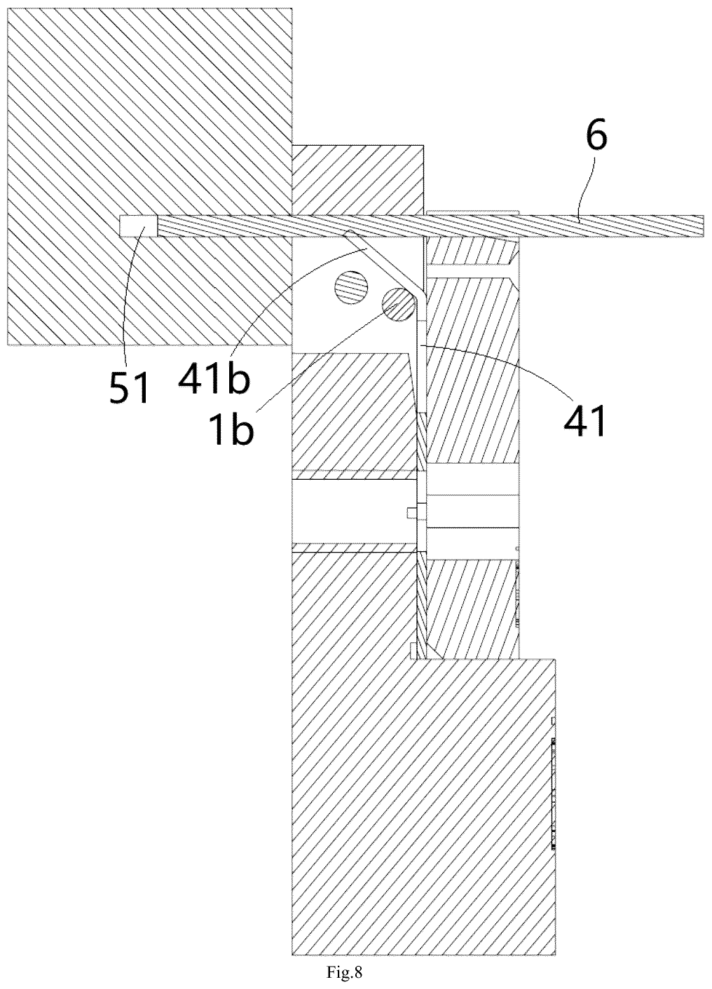

The locking component 4 includes a row of elastic cantilevers 41, shown in FIG. 4, corresponding to the row of slots 11. Each of the elastic cantilevers 41 extends into one of the slots 11, as shown in FIG. 3, and rests against the cable 6 inserted into the cable hole 51, as shown in FIG. 8, to prevent the inserted cable 6 from being pulled out of the cable hole 51 of the connector housing 5.

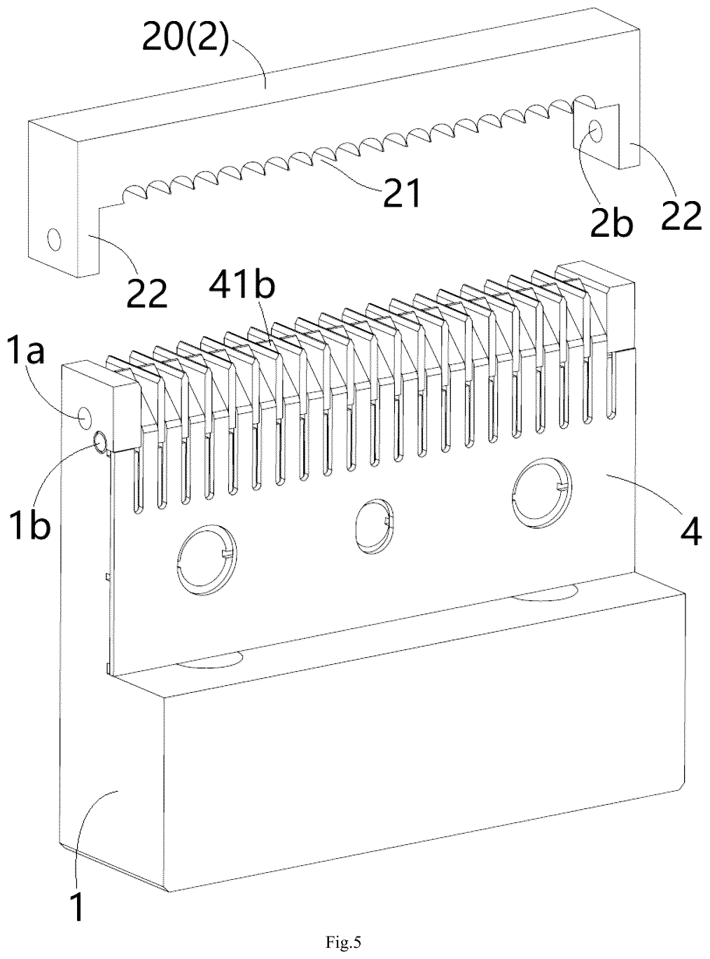

As shown in FIG. 4, in the illustrated embodiments, the slot 11 extends along the vertical direction Z and the first horizontal direction X and runs through the first block 1 in the first horizontal direction X. The upper semicircular hole 21, as shown in FIG. 5, runs through the second block 2 in the first horizontal direction X and aligns with the corresponding slot 11 in the vertical direction Z. The lower semicircular hole 31, as shown in FIG. 4, runs through the third block 3 in the first horizontal direction X and aligns with the corresponding slot 11 in the first horizontal direction X.

As shown in FIG. 4, in the illustrated embodiments, the locking member 4 further comprises a plate-shaped body 40, the row of elastic cantilevers 41 are connected to the upper side edge of the plate-shaped body 40, and the plate-shaped body 40 is clamped between the front side of the first block 1 and the rear side of the third block 3.

As shown in FIGS. 4 to 8, in the illustrated embodiments, the elastic cantilever 41 comprises a first arm portion 41a and a second arm portion 41b. One end of the first arm 41a is connected to the plate-shaped body 40 and extends in the vertical direction Z. The second arm 41b is connected to the other end of the first arm 41a and extends obliquely into the corresponding slot 11. The end of the second arm 41b presses against the inserted cable 6 to prevent the inserted cable 6 from being pulled out of the cable hole 51 of the connector housing 5. In the illustrated embodiment, the second arm 41b is in a barbed shape, thus preventing the inserted cable 6 from being pulled out of the cable hole 51 of the connector housing 5.

As shown in FIG. 4, in the illustrated embodiments, a row of unlocking holes 32 corresponding to the row of slots 11 are also formed on the third block 3, so that the elastic cantilever 41 can be pushed to the unlocking position separate from the inserted cable 6 by an unlocking tool inserted through the unlocking hole 32, allowing the inserted cable 6 to be pulled out of the cable hole 51 of the connector housing 5. The row of unlocking holes 32 are located below the row of the lower semicircular holes 31, and the unlocking hole 32 runs through the third block 3 in the first horizontal direction X and aligns with the corresponding slot 11 in the first horizontal direction X.

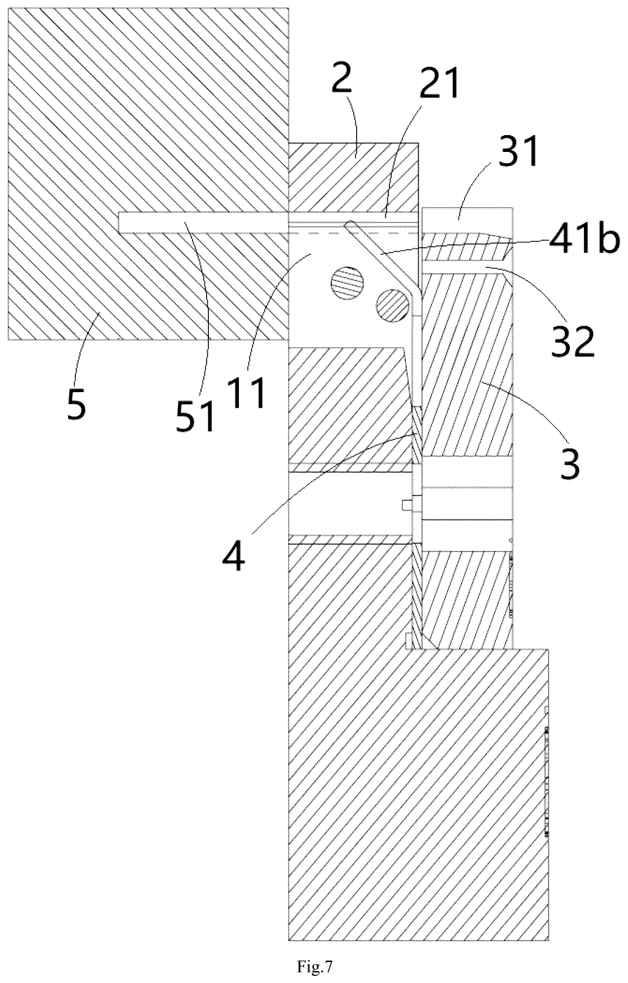

As shown in FIG. 4, in the illustrated embodiments, a horizontal step surface 1c is formed on the front side of the first block 1, and the bottom surfaces of the third block 3 and the locking component 4 are supported on the horizontal step surface 1c, as shown in FIGS. 7 and 8, to locate the third block 3 and the locking component 4 in the vertical direction Z.

As shown in FIG. 1, in the illustrated embodiments, connection holes 102 are respectively formed in the first block 1, the third block 3, and the locking component 4. The connection holes 102 are communicated with each other, so that the first block 1, the third block 3, and the locking component 4 can be fastened together through a connecting member (such as a bolt) that passes through the connection holes 102.

As shown in FIG. 5, in the illustrated embodiment, the second block 2 comprises a main body 20 and two connecting parts 22. The main body 20 has two opposite ends in a second horizontal direction Y perpendicular to the first horizontal direction X. The connecting parts 22 are located at both ends of the main body 20 and are rotatably connected to the first block 1. The row of upper semicircular holes 21 are formed on the bottom surface of the main body 20.

As shown in FIG. 5, in the illustrated embodiments, a first connecting hole 1a is formed on the first block 1, and the first connecting hole 1a runs through the first block 1 along the second horizontal direction Y. A second connecting hole 2b corresponding to the first connecting hole 1a is formed on the connecting part 22 of the second block 2. The cable insertion device also includes a connecting shaft 2a, shown in FIG. 1, which is rotatably installed into the first connecting hole 1a and the second connecting hole 2b to rotatably install the second block 2 onto the first block 1.

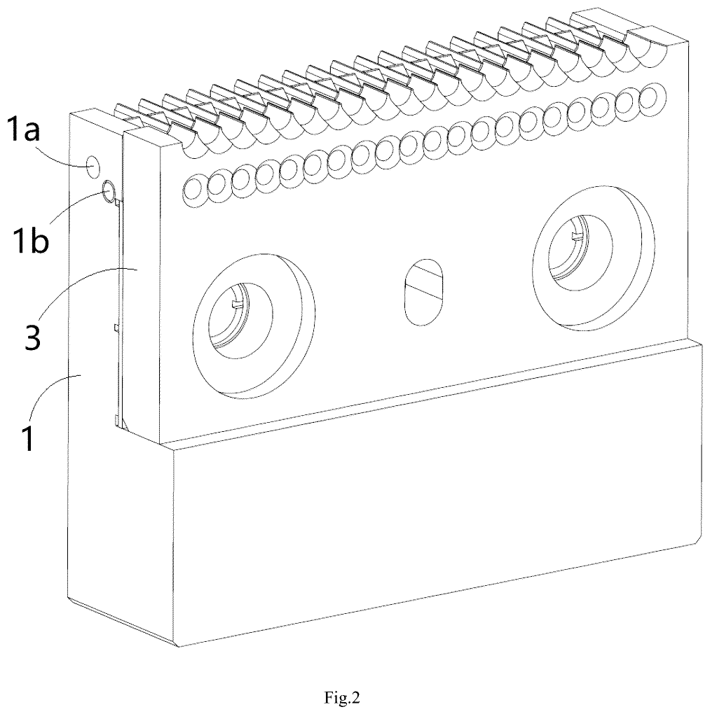

As shown in FIGS. 2, 4, 5, 6, and 8, in the illustrated embodiments, the cable insertion device further comprises a limiting shaft 1b, which is installed on the first block 1 and runs through the first block 1 in a second horizontal direction Y perpendicular to the first horizontal direction X. The limiting shaft 1b passes through the slot 11 and is used to rest against the elastic cantilever 41 of the locking component 4 to prevent excessive deformation of the elastic cantilever 41.

As shown in FIG. 7, in the illustrated embodiment, when the cable 6 is not inserted, the elastic cantilever 41 is in a natural state without force and does not contact the limiting shaft 1b. As shown in FIG. 8, in the illustrated embodiment, when the cable 6 is inserted, the elastic cantilever 41 is moved to the position in contact with the limiting shaft 1b under the pushing of the inserted cable 6. When the cable 6 is inserted, the limiting shaft 1b is supported on the connection portion between the first arm 41a and the second arm 41b.

In another exemplary embodiment of the present invention, a connector manufacturing device is also disclosed. The connector manufacturing device includes the above cable insertion device for guiding a cable 6 into a cable hole 51 of a connector housing 5. The cable insertion device is positioned on one side of the connector housing 5, and the guide hole 101 of the cable insertion device is aligned with the cable hole 51 of the connector housing 5. When the cable 6 is inserted into the cable hole 51 through the guide hole 101, the end of the elastic cantilever 41 of the locking component 4 is pressed against the inserted cable 6 to prevent the cable 6 from being pulled out of the cable hole 51 of the connector housing 5. Therefore, there is no need to provide a cable clamp, which reduces the manufacturing steps of the connector and improves the manufacturing efficiency of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A cable insertion device, comprising:
a first block having a top surface and a bottom surface opposite the top surface in a vertical direction, and a front side and a rear side opposite the front side in a first horizontal direction, a row of slots is formed on the top surface of the first block;
a second block assembled onto the top surface of the first block, a bottom surface of the second block is against the top surface of the first block, a row of upper semicircular holes corresponding to the row of slots is formed on the bottom surface of the second block;
a third block assembled onto the front side of the first block, a row of lower semicircular holes corresponding to the row of slots is formed on a top surface of the third block, one of the upper semicircular holes and one of the lower semicircular holes are combined into a guide hole for guiding a cable into a cable hole of a connector housing; and
a locking component clamped between the first block and the third block, the locking component has a row of elastic cantilevers corresponding to the row of slots, each of the elastic cantilevers extends into one of the slots and rests against the cable inserted into the cable hole to prevent the cable from being pulled out of the cable hole of the connector housing.

2. The cable insertion device according to claim 1, wherein the one of the slots extends along the vertical direction and the first horizontal direction and runs through the first block in the first horizontal direction.

3. The cable insertion device according to claim 2, wherein the one of the upper semicircular holes runs through the second block in the first horizontal direction and aligns with the one of the slots in the vertical direction, and the one of the lower semicircular holes runs through the third block in the first horizontal direction and aligns with the one of the slots in the first horizontal direction.

4. The cable insertion device according to claim 1, wherein the locking component has a plate-shaped body, the row of elastic cantilevers is connected to an upper side edge of the plate-shaped body, and the plate-shaped body is clamped between the front side of the first block and a rear side of the third block.

5. The cable insertion device according to claim 4, wherein the elastic cantilever includes a first arm extending in the vertical direction and having an end connected to the plate-shaped body, and a second arm connected to another end of the first arm and extending obliquely into the one of the slots.

6. The cable insertion device according to claim 5, wherein an end of the second arm rests against the cable to prevent the cable from being pulled out of the cable hole of the connector housing.

7. The cable insertion device according to claim 1, wherein a row of unlocking holes corresponding to the row of slots is formed on the third block, each of the elastic cantilevers can be pushed to an unlocking position separated from the cable by an unlocking tool inserted through one of the unlocking holes, allowing the cable to be pulled out of the cable hole of the connector housing.

8. The cable insertion device according to claim 7, wherein the row of unlocking holes is located below the row of lower semicircular holes, the one of the unlocking holes runs through the third block in the first horizontal direction and aligns with one of the slots in the first horizontal direction.

9. The cable insertion device according to claim 1, wherein a horizontal step surface is formed on the front side of the first block, and a bottom surface of the third block and a bottom surface of the locking component are supported on the horizontal step surface to position the third block and the locking component in the vertical direction.

10. The cable insertion device according to claim 9, wherein a plurality of connection holes are respectively formed in the first block, the third block, and the locking component and are communicated with each other, so that the first block, the third block, and the locking component can be fastened together through a connecting member passing through the connection holes.

11. The cable insertion device according to claim 1, wherein the second block includes a main body having a pair of opposite ends in a second horizontal direction perpendicular to the first horizontal direction, and a plurality of connecting parts disposed at the opposite ends of the main body and rotatably connected to the first block.

12. The cable insertion device according to claim 11, wherein the row of upper semicircular holes is formed on a bottom surface of the main body.

13. The cable insertion device according to claim 12, wherein a first connecting hole is formed in the first block, the first connecting hole runs through the first block along the second horizontal direction, and a second connecting hole corresponding to the first connecting hole is formed in one of the connecting parts of the second block.

14. The cable insertion device according to claim 13, further comprising a connecting shaft rotatably installed into the first connecting hole and the second connecting hole to rotatably install the second block onto the first block.

15. The cable insertion device according to claim 1, further comprising a limiting shaft installed on the first block and running through the first block along a second horizontal direction perpendicular to the first horizontal direction, the limiting shaft passes through the one of the slots and rests against one of the elastic cantilevers of the locking component to prevent excessive deformation of the elastic cantilever.

16. The cable insertion device according to claim 15, wherein, when the cable is not inserted, the elastic cantilevers are in a natural state without force and does not contact the limiting shaft, and when the cable is inserted, the elastic cantilever is moved to a position in contact with the limiting shaft under a pushing force of the cable.

17. The cable insertion device according to claim 16, wherein the locking component includes a plate-shaped body, the row of elastic cantilevers are connected to an upper side edge of the plate-shaped body, and the plate-shaped body is clamped between the front side of the first block and a rear side of the third block.

18. The cable insertion device according to claim 17, wherein the elastic cantilever includes a first arm extending in a vertical direction and having an end connected to the plate-shaped body, and a second arm connected to another end of the first arm and extending obliquely into the one of the slots, an end of the second arm rests against the cable to prevent the cable from being pulled out of the cable hole of the connector housing.

19. The cable insertion device according to claim 18, wherein, when the cable is inserted, the limiting shaft is supported on a connecting portion between the first arm and the second arm.

20. A connector manufacturing device, comprising:
the cable insertion device as claimed in claim 1, the cable insertion device is positioned on a side of the connector housing, the guide hole of the cable insertion device is aligned with the cable hole of the connector housing, and when the cable is inserted into the cable hole through the guide hole, an end of the elastic cantilever of the locking component is against the cable to prevent it from being pulled out of the cable hole of the connector housing.
